(19) United States
(12) Patent Application Publication
(10) Pub. No.: US 2018/0302213 A1
(43) Pub. Date: Oct. 18, 2018

(54) METHODS, SYSTEMS, AND COMPUTER PROGRAM PRODUCTS FOR COMMUNICATION CHANNEL PREDICTION FROM RECEIVED MULTIPATH COMMUNICATIONS IN A WIRELESS COMMUNICATIONS SYSTEM

(71) Applicant: Collision Communications, Inc., Peterborough, NH (US)

(72) Inventors: Sayak Bose, Nashua, NH (US); Brandon Hombs, Merrimack, NH (US)

(21) Appl. No.: 15/489,579

(22) Filed: Apr. 17, 2017

(51) Int. Cl. H04L 7/033; H04L 25/02; H04L 7/00; H04B 7/06

(52) U.S. Cl. CPC H04L 7/033; H04L 25/022; H04L 45/24; H04B 7/0617; H04L 7/0058

(57) ABSTRACT

Methods and systems are described for communication channel prediction from received multipath communications in a wireless communications system. In one aspect, a baseband impairment compensation of at least one of sample frequency offset, carrier frequency offset, and time offset between a wireless transmitter and a wireless receiver is estimated. A plurality of complex value channel tap estimates is received for each of a plurality of channel taps. A plurality of complex value channel tap predictions is determined for a future multipath communication based on the prior received corresponding complex value channel tap estimates and the baseband impairment compensation.

### BACKGROUND

In a wireless system, downlink beamforming is essential to extend cell coverage and to provide increased signal strength and reduced interference to a mobile terminal, resulting in a higher data rate without the need for increasing power or bandwidth. To perform effective downlink beamforming, it is essential to estimate the channel at the transmit side, such as at a base station. This is almost always impossible as it requires excessive transmission overhead beyond the capability of a practical wireless system infrastructure. An alternative is to use an estimate of the receive channel as an estimate of the transmit side assuming, in a time division duplex fashion, that the channel remains constant between a reception and a subsequent transmission. In many cases, especially in a moderately to high mobility environment, this turns out to be an invalid assumption because the channel changes and the estimate becomes stale by the time of the next transmission. Additionally, infrequent channel estimates due to sparse channel sounding intervals on the uplink adds to the relative staleness of the channel estimate.

Beamforming with this stale channel estimate performs poorly with respect to achievable downlink throughput, especially in a mobile environment. Additionally, even if the channel remains relatively static, the baseband oscillator always experiences time-varying drifts due to temperature differences, component aging, and other factors, and appears as an additional Doppler frequency and clock offset inside the baseband signal samples. Correcting the carrier frequency offset associated with the baseband clock drift is therefore important for providing optimal long-range channel prediction and beamforming.

Accordingly, there exists a need for methods, systems, and computer program products for communication channel prediction from received multipath communications in a wireless communications system.

### SUMMARY

Methods and systems are described for communication channel prediction from received multipath communications in a wireless communications system. In one aspect, a baseband impairment compensation of at least one of a sample frequency offset, carrier frequency offset, and time offset between a wireless transmitter and a wireless receiver is estimated. A plurality of complex value channel tap estimates is received for each of a plurality of channel taps. A plurality of complex value channel tap predictions is determined for a future multipath communication based on the prior received corresponding complex value channel tap estimates and the baseband impairment compensation.

### BRIEF DESCRIPTION OF THE DRAWINGS

Advantages of the claimed invention will become apparent to those skilled in the art upon reading this description in conjunction with the accompanying drawings, in which like reference numerals have been used to designate like or analogous elements, and in which:

FIG. 1 is a block diagram illustrating an exemplary hardware device in which the subject matter may be implemented;

FIG. 2 is a flow diagram illustrating a method for communication channel prediction from received multipath communications in a wireless communications system according to an aspect of the subject matter described herein;

FIG. 3 is a block diagram illustrating an arrangement of components for communication channel prediction from received multipath communications in a wireless communications system according to another aspect of the subject matter described herein; and

FIG. 4 is an exemplary block diagram logical representation of a state-space model for communication channel prediction from received multipath communications according to another aspect of the subject matter described herein.

### DETAILED DESCRIPTION

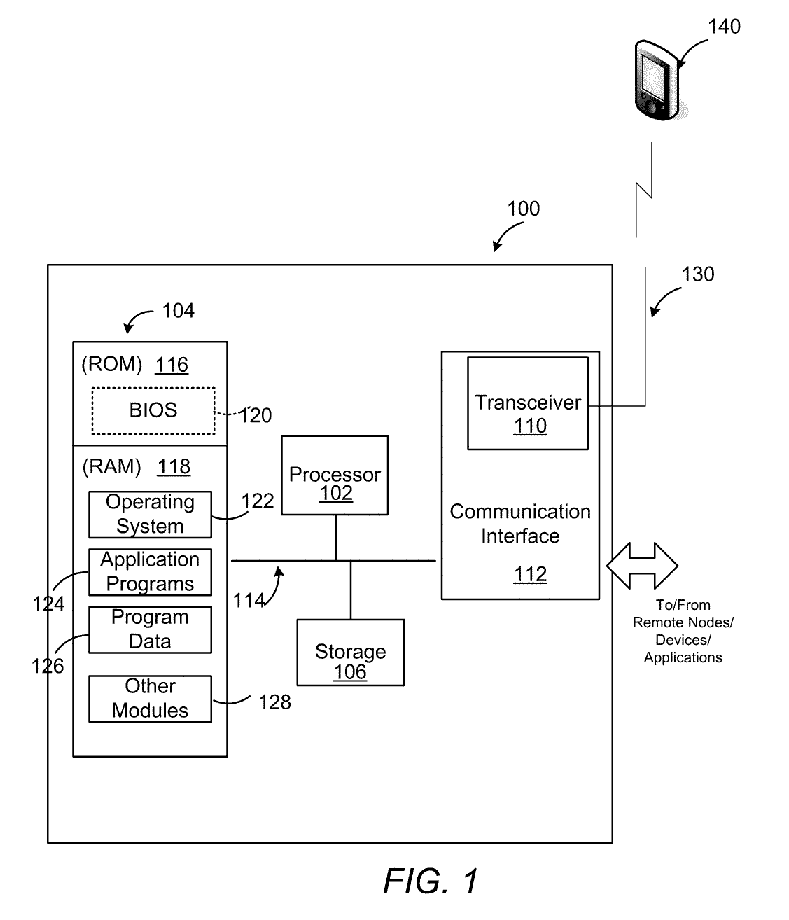

Prior to describing the subject matter in detail, an exemplary hardware device in which the subject matter may be implemented shall first be described. Those of ordinary skill in the art will appreciate that the elements illustrated in FIG. 1 may vary depending on the system implementation. With reference to FIG. 1, an exemplary system for implementing the subject matter disclosed herein includes a hardware device 100, including a processing unit 102, memory 104, storage 106, transceiver 110, communication interface 112, and a bus 114 that couples elements 104-112 to the processing unit 102.

The bus 114 may comprise any type of bus architecture. Examples include a memory bus, a peripheral bus, a local bus, etc. The processing unit 102 is an instruction execution machine, apparatus, or device and may comprise a microprocessor, a digital signal processor, a graphics processing unit, an application specific integrated circuit (ASIC), a field programmable gate array (FPGA), etc. The processing unit 102 may be configured to execute program instructions stored in memory 104 and/or storage 106.

The memory 104 may include read only memory (ROM) 116 and random access memory (RAM) 118. Memory 104 may be configured to store program instructions and data during operation of device 100. In various embodiments, memory 104 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory 104 may also include nonvolatile memory technologies such as nonvolatile flash RAM (NVRAM) or ROM. In some embodiments, it is contemplated that memory 104 may include a combination of technologies such as the foregoing, as well as other technologies not specifically mentioned. When the subject matter is implemented in a computer system, a basic input/output system (BIOS) 120, containing the basic routines that help to transfer information between elements within the computer system, such as during start-up, is stored in ROM 116.

The storage 106 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 100. It is noted that the methods described herein can be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 106, ROM 116 or RAM 118, including an operating system 122, one or more applications programs 124, program data 126, and other program modules 128.

The hardware device 100 may be part of a base station (not shown) configured to communicate with mobile devices 140 in a communication network. A base station may also be referred to as an eNodeB, an access point, and the like. A base station typically provides communication coverage for a particular geographic area. A base station and/or base station subsystem may cover a particular geographic coverage area referred to by the term “cell.” A network controller (not shown) may be communicatively connected to base stations and provide coordination and control for the base stations. Multiple base stations may communicate with one another, e.g., directly or indirectly via a wireless backhaul or wireline backhaul.

The hardware device 100 may operate in a networked environment using logical connections to one or more remote nodes via communication interface 112, including communicating with one or more mobile devices 140 via a transceiver 110 connected to an antenna 130. The mobile devices 140 can be dispersed throughout the network 100. A mobile device may be referred to as user equipment (UE), a terminal, a mobile station, a subscriber unit, or the like. A mobile device may be a cellular phone, a personal digital assistant (PDA), a wireless modem, a wireless communication device, a handheld device, a laptop computer, a wireless local loop (WLL) station, a tablet computer, or the like. A mobile device may communicate with a base station directly, or indirectly via other network equipment such as, but not limited to, a pico eNodeB, a femto eNodeB, a relay, or the like.

The remote node may be a computer, a server, a router, a peer device or other common network node, and typically includes many or all of the elements described above relative to the hardware device 100. The communication interface 112, including transceiver 110 may interface with a wireless network and/or a wired network. For example, wireless communications networks can include, but are not limited to, Code Division Multiple Access (CDMA), Time Division Multiple Access (TDMA), Frequency Division Multiple Access (FDMA), Orthogonal Frequency Division Multiple Access (OFDMA), and Single-Carrier Frequency Division Multiple Access (SC-FDMA). A CDMA network may implement a radio technology such as Universal Terrestrial Radio Access (UTRA), Telecommunications Industry Association's (TIA's) CDMA2000®, and the like. The UTRA technology includes Wideband CDMA (WCDMA), and other variants of CDMA. The CDMA2000® technology includes the IS-2000, IS-95, and IS-856 standards from The Electronics Industry Alliance (EIA), and TIA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advance (LTE-A) are newer releases of the UMTS that use E-UTRA. UTRA, E-UTRA, UMTS, LTE, LTE-A, and GAM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies.

Other examples of wireless networks include, for example, a BLUETOOTH network, a wireless personal area network, and a wireless 802.11 local area network (LAN). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 112 may include logic configured to support direct memory access (DMA) transfers between memory 104 and other devices.

In a networked environment, program modules depicted relative to the hardware device 100, or portions thereof, may be stored in a remote storage device, such as, for example, on a server. It will be appreciated that other hardware and/or software to establish a communications link between the hardware device 100 and other devices may be used.

It should be understood that the arrangement of hardware device 100 illustrated in FIG. 1 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of hardware device 100. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 1. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description that follows, the subject matter will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described below, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

To alleviate the staleness of the channel estimate for effective downlink channel prediction in a challenging fading environment, it is helpful to predict the downlink channel ahead of time from the previous samples of channel estimates, mainly during the uplink channel sounding process. This approach provides predictions of the downlink channel that represent the current state of the channel for use in, e.g., beamforming, instead of a previous state. This method is very effective in a slowly fading to moderately fading environment, which covers a majority of data traffic environments.

In one aspect, a plurality of complex value channel tap predictions can be determined by applying a state-space model having a non-linear function of carrier frequency offset, Doppler frequencies, phases, amplitudes, and a sampled time of arrival of the channel taps. For example, the state-space model can employ an algorithm including at least one of an Extended Kalman filter, an Unscented Kalman filter, a Particle filter, and a Neural Network and Backpropagation algorithm. Moreover, the state-space model can be an auto-regressive model where time-evolution of estimated channel taps can be done using the state-space model and associated filtering.

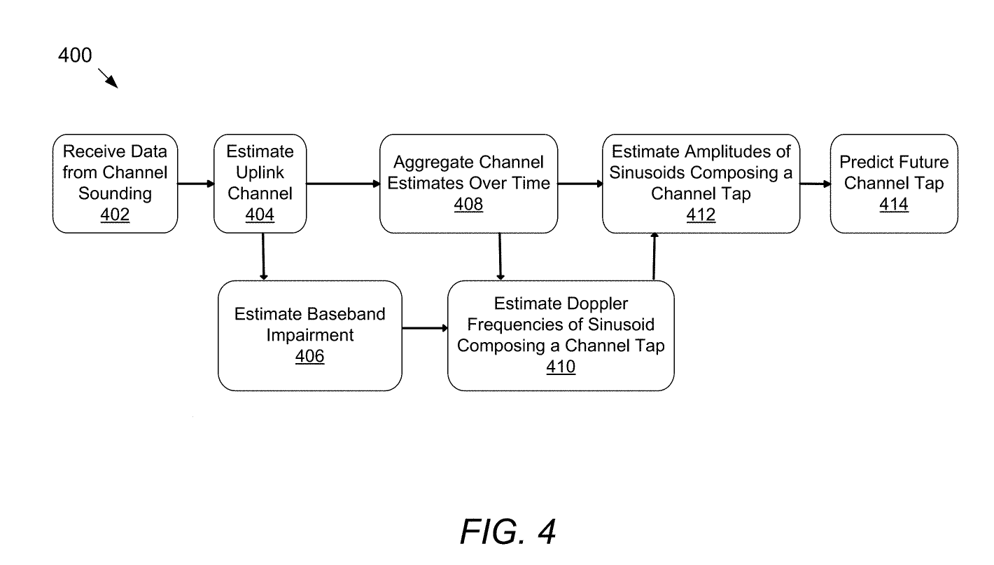

FIG. 4 is an exemplary block diagram logical representation 400 of a state-space model for communication channel prediction from received multipath communications according to one aspect of the subject matter described herein. With reference to FIG. 4, the uplink channel is estimated 404 from received sounding reference signals (“SRS”) 402. For example, an estimate can be done after receiving a sequence of consecutive uplink transmissions from a UE during channel sounding intervals. The uplink channel estimates are aggregated over time 408. The uplink channel estimates are also used to estimate baseband impairment 406. As used herein, the term “baseband impairment” represents a sample frequency offset, carrier frequency offset, and/or time offset between a wireless transmitter and a wireless receiver. For example, a change in carrier frequency offset due to local oscillator drifts between transmitter and receiver side can be estimated. In one aspect, sample frequency offset and/or carrier frequency offset are estimated using adaptive filtering techniques, such as a Kalman Filter. As an example, the carrier frequency offsets can be estimated from the phase difference of two identical symbols (one delayed by some known samples). Similarly, sample frequency offset can be obtained from time correlations of the received data samples with training sequence generated at known sampling instants. The Doppler frequencies for the component sinusoids composing a channel tap in the time domain are estimated 410. For example, Multiple Signal Classification (“MUSIC”) methods can be employed to estimate the Doppler frequencies from the sequence of channel sample estimates based on an assumption that Doppler frequency change is slow compared to amplitude and phase changes of the component sinusoids composing the channel taps. In another aspect, a residual carrier frequency and sample time offset are modeled using at least one of a second order Phase-Lock Loop (“PLL”) filter and a Kalman filter to track variations.

The amplitudes of sinusoids composing the channel taps are then estimated 412 from the aggregated channel estimates 408 and the Doppler frequency estimates 410 to predict a future complex channel tap. Each channel tap can therefore be predicted over a long time period using an augmented Kalman filter model or using separate tracking algorithms of lower complexity easily and with sufficient accuracy. In another aspect, each channel tap can be modeled as a sum of sinusoids with non-zero Doppler frequencies determined by using a signal classification algorithm such as MUSIC, Estimation of Signal Parameters via Rotational Invariance Technique (“ESPIRIT”), and/or Fast Fourier Transform (“FFT”) based algorithms. Without accounting for sample frequency offset and/or carrier frequency offset, tracking channel estimates obtained by using various super-resolution signal classification type algorithms, such as MUSIC and ESPIRIT, do not perform well in a practical deployment scenario.

The exemplary model 400 can be run recursively to estimate channel state. Once the model converges, assuming the Doppler frequencies remain constant for the component sinusoids of a channel tap, the model can predict 414 the amplitude and phase of the channel tap for any future transmission instant where, e.g., transmit beamforming is performed. In an aspect, multiple user's channels can be jointly predicted by a Kalman filter based long range predictor.

In an aspect, the channel prediction component can be configured to determine a plurality of complex value channel tap predictions by jointly estimating multiple complex value channel taps and the baseband impairment compensation. For example, a state space model of complex channel taps that also tracks sample frequency offset and the time of arrival of the multipath components jointly can be done using an augmented state-space model with the impairments modeled into it. Concretely, instead of assuming the arriving channel taps are independent, correlations among the taps are exploited in the joint state state-space model. For instance, this correlation can be modeled as part of the process noise in a Kalman filter state-space model formulation. This concept can be extended to the multi-user case as well, where the arriving taps from multiple users at a point in time can also be correlated. With this joint state-space model, a non-linear estimator-predictor filter should be used to estimate and predict the channel taps along with impairments. In an aspect, multiple user's channels can be jointly predicted by a Kalman filter or its non-linear variants based long range predictor.

An exemplary state space model can be shown mathematically as follows:

State-space model: x_{k|k-1}=f(x_{k-1|k-1}),

Observation model: zₖ=g(xₖ)+vₖ,

where the state variable is comprised of x_{k|k-1}=f([tDoA,a,f_{d},f_{offset}]), where tDoA is the time offset representing the time difference of arrival of a channel tap between its true and estimated arrival times, a is the vector amplitudes of the component sinusoids, f_{d} is the vector Doppler frequencies of the component sinusoids and f_{offset} is the estimated sample frequency offset. The observation variable zₖ is obtained as g(hₖ,f(t_{DoA}),f_{Clock}), where f_{Clock} is the sampling clock frequency corrected over time though the model and observation.

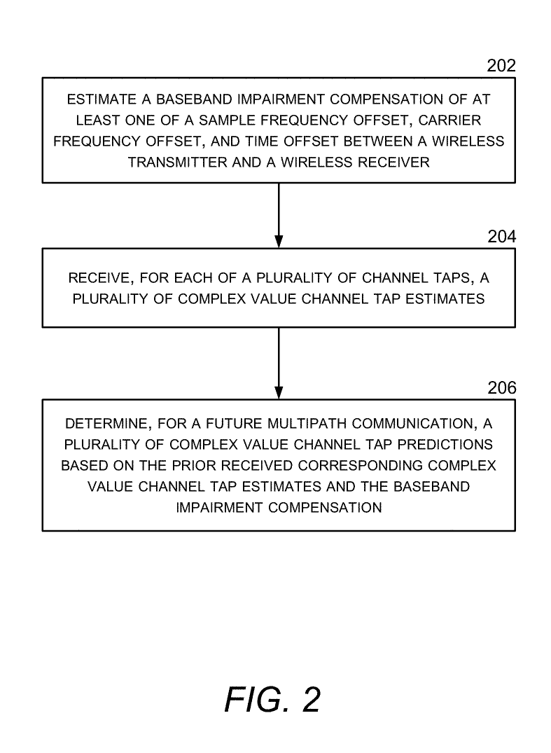

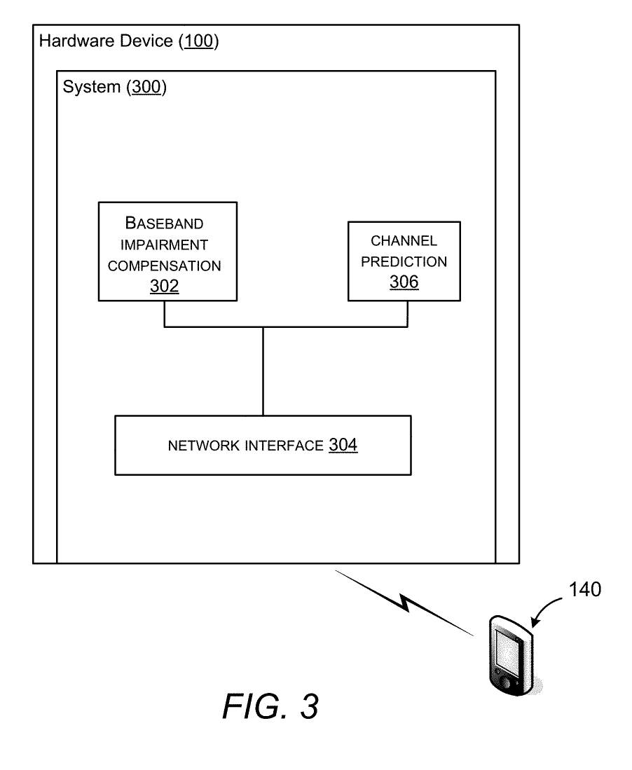

Turning now to FIG. 2, a flow diagram is illustrated illustrating a method for communication channel prediction from received multipath communications in a wireless communications system according to an exemplary aspect of the subject matter described herein. FIG. 3 is a block diagram illustrating an arrangement of components for communication channel prediction from received multipath communications in a wireless communications system according to another exemplary aspect of the subject matter described herein. FIG. 1 is a block diagram illustrating an arrangement of components providing an execution environment configured for hosting the arrangement of components depicted in FIG. 3. The method in FIG. 2 can be carried out by, for example, some or all of the components illustrated in the exemplary arrangement in FIG. 3 operating in a compatible execution environment, such as the environment provided by some or all of the components of the arrangement in FIG. 1. The arrangement of components in FIG. 3 may be implemented by some or all of the components of the hardware device 100 of FIG. 1.

With reference to FIG. 2, in block 202 a baseband impairment compensation of at least one of a sample frequency offset, carrier frequency offset, and time offset between a wireless transmitter and a wireless receiver is estimated. Accordingly, a system for communication channel prediction from received multipath communications in a wireless communications system includes means for estimating a baseband impairment compensation between a wireless transmitter and a wireless receiver. For example, as illustrated in FIG. 3, a baseband impairment compensation component 302 is configured to estimate a baseband impairment compensation between a wireless transmitter and a wireless receiver.

In block 204 a plurality of complex value channel tap estimates are received for each of a plurality of channel taps. Accordingly, a system for communication channel prediction from received multipath communications in a wireless communications system includes means for receiving, for each of a plurality of channel taps, a plurality of complex value channel tap estimates. For example, as illustrated in FIG. 3, a network interface component 304 is configured to receive, for each of a plurality of channel taps, a plurality of complex value channel tap estimates.

In block 206 a plurality of complex value channel tap predictions based on the prior received corresponding complex value channel tap estimates and the baseband impairment compensation is determined for a future multipath communication. Accordingly, a system for communication channel prediction from received multipath communications in a wireless communications system includes means for determining, for a future multipath communication, a plurality of complex value channel tap predictions based on the prior received corresponding complex value channel tap estimates and the baseband impairment compensation. For example, as illustrated in FIG. 3, a channel prediction component 306 is configured to determine, for a future multipath communication, a plurality of complex value channel tap predictions based on the prior received corresponding complex value channel tap estimates and the baseband impairment compensation.

The methods described herein can be generally used for estimating and predicting the time evolution of the fading process in a wireless communications system for a longer range than previously possible. The methods can be straightforwardly extended to a wireless communication system having multiple transmit-receive antenna. For example, in a TDD-LTE system, channel sounding reference signals (SRS) can be used to obtain the channel tap estimation, baseband impairment compensation and prediction using methods describe herein. An effective coherent beamforming solution using this method is therefore possible that reduces variations in signal to noise ratio at the receiver due to fading. In an aspect, the channel prediction component can be configured to process the complex value channel tap predictions to calibrate multiple transmit antennas for coherent beamforming or to process the complex value channel tap predictions for beamforming. In another aspect, methods described herein can be used in a multi-user multiple antenna system and the channel prediction component can be configured to process each users' complex value channel tap predictions separately for beamforming. In another aspect, the channel prediction component can be configured to process the complex value channel tap predictions for multi-user beamforming based on block diagonalization, minimum mean squared error, or any other beamforming criteria.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. One of ordinary skill in the art should appreciate after learning the teachings related to the claimed subject matter contained in the foregoing description that variations of those preferred embodiments may become apparent to those of ordinary skill in the art upon reading the foregoing description. The inventor intends that the claimed subject matter may be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A method for communication channel prediction from received multipath communications in a wireless communications system, the method comprising:
estimating a baseband impairment compensation of at least one of a sample frequency offset, carrier frequency offset, and time offset between a wireless transmitter and a wireless receiver;
receiving, for each of a plurality of channel taps, a plurality of complex value channel tap estimates; and
determining, for a future multipath communication, a plurality of complex value channel tap predictions based on the prior received corresponding complex value channel tap estimates and the baseband impairment compensation;
wherein at least one of the preceding actions is performed by at least one electronic hardware component.

2. The method of claim 1, wherein determining a plurality of complex value channel tap predictions includes jointly estimating multiple complex value channel taps and the baseband impairment compensation.

3. The method of claim 1, wherein each channel tap is modeled as a sum of sinusoids with non-zero Doppler frequencies determined by using a signal classification algorithm.

4. The method of claim 3, wherein the signal classification algorithm is at least one of Multiple Signal Classification (“MUSIC”), Estimation of Signal Parameters via Rotational Invariance Technique (“ESPIRIT”), and Fast Fourier Transform (“FFT”) based.

5. The method of claim 1, wherein determining a plurality of complex value channel tap predictions includes applying a state-space model having a non-linear function of carrier frequency offset, Doppler frequencies, phases, amplitudes, and a sampled time of arrival of the channel taps.

6. The method of claim 5, wherein the state-space model employs an algorithm including at least one of an Extended Kalman filter, an Unscented Kalman filter, a Particle filter, and a Neural Network and Backpropagation algorithm.

7. The method of claim 5, wherein the state-space model is an auto-regressive model where time-evolution of estimated channel taps is done using the state-space model and associated filtering.

8. The method of claim 2, wherein multiple user's channels are jointly predicted by a Kalman filter based long range predictor.

9. The method of claim 1, wherein a residual carrier frequency and sample time offset are modeled using at least one of a second order Phase-Lock Loop (“PLL”) filter and a Kalman filter to track variations.

10. The method of claim 1, wherein the wireless communications system is a multiple antenna transmit-receive wireless communications system.

11. The method of claim 1, wherein the complex value channel tap predictions are processed and used to calibrate multiple transmit antenna for coherent beamforming.

12. The method of claim 1, wherein the complex value channel tap predictions are processed and provided to multiple transmit antennas for beamforming.

13. The method of claim 1, wherein the wireless communication system is a multi-user multiple antenna system and each users' complex value channel tap predictions are separately processed and provided to an antenna for beamforming.

14. The method of claim 1, wherein the complex value channel tap predictions are processed for multi-user beamforming based on block diagonalization and spatial water-filing for power allocation jointly over multiple transmit antennas.

15. system for communication channel prediction from received multipath communications in a wireless communications system, the system comprising:
means for estimating a baseband impairment compensation of at least one of a sample frequency offset, carrier frequency offset, and time offset between a wireless transmitter and a wireless receiver;
means for receiving, for each of a plurality of channel taps, a plurality of complex value channel tap estimates; and
means for determining, for a future multipath communication, a plurality of complex value channel tap predictions based on the prior received corresponding complex value channel tap estimates and the baseband impairment compensation,
wherein at least one of the means includes at least one electronic hardware component.

16. A system for communication channel prediction from received multipath communications in a wireless communications system, the system comprising system components including:
a compensation component configured for estimating a baseband impairment compensation of at least one of a sample frequency offset, carrier frequency offset, and time offset between a wireless transmitter and a wireless receiver; and
a network interface component configured for receiving, for each of a plurality of channel taps, a plurality of complex value channel tap estimates;
a channel prediction component configured for determining, for a future multipath communication, a plurality of complex value channel tap predictions based on the prior received corresponding complex value channel tap estimates and the baseband impairment compensation,
wherein at least one of the system components includes at least one electronic hardware component.

17. The system of claim 1, wherein the channel prediction component is configured to determine a plurality of complex value channel tap predictions by jointly estimating multiple complex value channel taps and the baseband impairment compensation.

18. The system of claim 1, wherein each channel tap is modeled as a sum of sinusoids with non-zero Doppler frequencies determined by using a signal classification algorithm.

19. The system of claim 18, wherein the signal classification algorithm is at least one of Multiple Signal Classification (“MUSIC”), Estimation of Signal Parameters via Rotational Invariance Technique (“ESPIRIT”), and Fast Fourier Transform (“FFT”) based.

20. The system of claim 1, wherein the channel prediction component is configured to determine a plurality of complex value channel tap predictions by applying a state-space model having a non-linear function of carrier frequency offset, Doppler frequencies, phases, amplitudes, and a sampled time of arrival of the channel taps.

21. The system of claim 20, wherein the state-space model employs an algorithm including at least one of an Extended Kalman filter, an Unscented Kalman filter, a Particle filter, and a Neural Network and Backpropagation algorithm.

22. The system of claim 20, wherein the state-space model is an auto-regressive model where time-evolution of estimated channel taps is done using the state-space model and associated filtering.

23. The system of claim 17, wherein multiple user's channels are jointly predicted by a Kalman filter based long range predictor.

24. The system of claim 1, wherein a residual carrier frequency and sample time offset are modeled using at least one of a second order Phase-Lock Loop (“PLL”) filter and a Kalman filter to track variations.

25. The system of claim 1, wherein the wireless communications system is a multiple antenna transmit-receive wireless communications system.

26. The system of claim 1, wherein the channel prediction component is configured to process the complex value channel tap predictions to calibrate multiple transmit antennas for coherent beamforming.

27. The system of claim 1, wherein the channel prediction component is configured to process the complex value channel tap predictions for beamforming.

28. The system of claim 1, wherein the wireless communication system is a multi-user multiple antenna system and the channel prediction component is configured to process each users' complex value channel tap predictions separately for beamforming.

29. The system of claim 1, wherein the channel prediction component is configured to process the complex value channel tap predictions for multi-user beamforming based on block diagonalization and spatial water-filing for power allocation jointly over multiple transmit antennas.

30. A non-transitory computer readable medium storing a computer program, executable by a machine, for communication channel prediction from received multipath communications in a wireless communications system, the computer program comprising executable instructions for:
estimating a baseband impairment compensation of at least one of a sample frequency offset, carrier frequency offset, and time offset between a wireless transmitter and a wireless receiver;
receiving, for each of a plurality of channel taps, a plurality of complex value channel tap estimates; and
determining, for a future multipath communication, a plurality of complex value channel tap predictions based on the prior received corresponding complex value channel tap estimates and the baseband impairment compensation.
